(19) United States
(12) Patent Application Publication
(10) Pub. No.: US 2016/0332282 A1
(43) Pub. Date: Nov. 17, 2016

(54) PROTECTIVE ENCLOSURE FOR A MOVABLE TOOL FOR DISPENSING FLUID AT A CRYOGENIC TEMPERATURE

(71) Applicant: L'AIR LIQUIDE, SOCIETE ANONYME POUR L'ETUDE ET L'EXPLOITATION DES PROCEDES GEORGES CLAUDE, Paris (FR)

(72) Inventors: David BIGOT, Villepreux, TX (US); Jacques QUINTARD, Presles (FR); Frédéric RICHARD, Parmain (FR); Charles TRUCHOT, Saint Nazaire (FR); Fabrice MOGGIA, Gif sur Yvette (FR); Laurent OBJOIS, Chatenay-Malabry (FR)

(21) Appl. No.: 15/106,422

(22) PCT Filed: Dec. 17, 2014
(86) PCT No.: PCT/FR2014/053389

§ 371 Date: Jun. 20, 2016

(30) Foreign Application Priority Data
Dec. 20, 2013 (FR) 1363205

(51) Int. Cl. B24C 1/00; B08B 3/02; B24C 9/00

(52) U.S. Cl. CPC B24C 1/003; B24C 9/003; B08B 3/02

(57) ABSTRACT

The invention relates to a protective enclosure for a mobile tool for dispensing fluid at a cryogenic temperature, said protective enclosure comprising an open end forming an extraction bell, said open end comprising a skirt, characterized in that the skirt comprises a first part made from a hydrophobic first material.

### TECHNICAL FIELD OF THE INVENTION

The invention relates to a protective enclosure for a mobile tool for dispensing fluid at a cryogenic temperature.

This enclosure for protecting a mobile tool forms part of an installation for the stripping, scaling, surface-treatment of materials that may or may not be coated, such as metals, concrete, wood, polymers, plastics or any other type of material, using a very high pressure jet of fluid at a cryogenic temperature.

### PRIOR ART

At the present time, the surface-treatment of materials that may or may not be coated, particularly the stripping, scaling or the like of concrete, paint, etc., is performed essentially by sandblasting, by ultra high pressure (UHP) water jet, using a sander, a jackhammer, a roughening tool, or alternatively via a chemical route.

However, when there must not be any water, for example in a nuclear environment, or any chemical product, for example because of drastic environmental constraints, only working methods referred to as “dry” methods can be used.

However, in some cases, these “dry” methods are difficult to employ, are very laborious or painstaking to use, or even generate additional pollution, for example because of the addition of shot or sand which has to be subsequently reprocessed.

One alternative to these technologies resides in the use of very high pressure cryogenic jets as proposed in documents U.S. Pat. No. 7,310,955 and U.S. Pat. No. 7,316,363. In that case, one or more jets of liquid nitrogen is used at a pressure of 1000 to 4000 bar and at a cryogenic temperature (comprised for example between −100 and −200° C., typically between around −125 and −160° C.) which are dispensed by a nozzle holder tool which is set in motion, typically with a rotational or oscillatory movement.

Now, if gaseous nitrogen (it passes from the liquid to gaseous state as it leaves the nozzles) delivered by the nozzles, is released or let out into the room in which the surface treatment is being performed, creates the risk of anoxia to the operator, particularly if this nitrogen builds up and if the room has little or no ventilation.

Furthermore, it is sometimes necessary to collect the residue (particles, dust) produced during the surface treatment, directly at source in order to prevent these from contaminating the site at which the surface treatment, for example a surface stripping, operation is being performed, particularly when it is a matter of scaling concrete in a radioactive environment.

For these reasons, a protective enclosure, referred to as an extraction bell, is generally arranged around the mobile fluid-dispensing tool (or tools), i.e. the surface treatment tool from which the jet of liquid nitrogen emerges, said bell generally being equipped with a skirt, preferably flexible, which acts as a mechanical barrier and ensures contact between the extraction bell and the surface that is to be treated. This skirt may be equipped with or formed from one or more row(s) of flexible bristles, an elastic strip (for example made of rubber, leather, elastomer, etc.), one or more wads of foam, etc. This extraction bell makes it possible to create partial sealing between the tool and the surface that is to be treated and allows all or some of the nitrogen delivered by the nozzles and the residue produced during the surface treatment to be extracted.

The extraction system used needs to be at a reduced pressure so as to avoid rereleasing nitrogen into the room/worksite and so that the surface residue can be sucked up effectively.

The nitrogen ejected by the nozzle holder tool and the dust and waste, such as pieces of concrete or the like, are sucked up by the extraction bell. To ensure maximum extraction efficiency, the suction capacity must be greater that the nitrogen flow rate at the tool. Thus, external air is also sucked up.

However, the ambient air sucked up contains moisture, namely water vapor, which finds its way into the extraction system. Now, moisture sucked up is a major problem. This is because the moisture adsorbs onto the skirt, notably the bristles or the like, and therefore turns into ice upon contact with the low temperatures to which the bell is subjected. This may prove very troublesome for handling because the elements that make up the skirt, such as bristles, because of their flexibility are normally supposed to perform a fundamental role of ensuring contact between the extraction bell and the surface that is to be treated. Now, if these elements set solid and become stiff, contact between the bell and the substrate becomes very poor because it is not very well “sealed”. This then results in poor-quality extraction which means to say that chippings, dust or other waste will “contaminate” the room in which the treatment is being performed. This is prohibitive, notably in industries in which the surface residue has imperatively to be extracted, such as the nuclear or chemical industries for example.

Also, for applications such as the scaling of concrete, each jet of liquid nitrogen shatters the surface of the concrete and propels the bits of concrete in all directions. These concrete particles then strike the inside of the extraction bell and the skirt, thus causing fairly rapid wearing of the latter depending on the materials of which the skirt is made. The choice of these materials is a deciding factor in achieving a skirt life that is sufficiently long and compatible with use on an industrial scale.

One way of limiting or even eliminating the freezing-solid of ice on the constituent parts of the skirt, such as brushes and bristles, is to prevent the arrival of external air naturally laden with moisture by resorting to a double-walled extraction bell associated with the delivery of a dry gas, for example nitrogen. This point was mentioned in patent application WO10133784. This first solution has the disadvantages of requiring the addition of a gas to a contaminated zone, something which is difficult to achieve, and in addition of oversizing the extraction bell for the dry gas, leading to additional costs. A second solution for limiting or even preventing the formation of ice at the brushes is to add a heat source, an electrical resistance or a heating cover for example, near the skirt, so as to counter the supply of frigories coming from the jet of liquid nitrogen. That solution is described in the French patent application published under No. FR2945761. It has the disadvantage of requiring a source of electrical power to the tool and the extraction bell, thus making the method more complex.

The invention seeks to overcome all or some of the disadvantages of the prior art as identified hereinabove and notably to propose means that make it possible to prevent the ice from setting solid.

### SUMMARY OF THE INVENTION

To this end, one aspect of the invention relates to a protective enclosure for a mobile tool for dispensing fluid at a cryogenic temperature, said protective enclosure comprising an open end forming an extraction bell, said open end comprising a skirt, characterized in that the skirt comprises a first part made from a hydrophobic first material.

Resorting to a first material that is hydrophobic makes it possible to limit or even eliminate the setting-solid of ice on the constituent elements of the first part of the skirt when operating at a cryogenic temperature. This solution offers the advantage of being simple to implement; specifically it does not require any additional element. A hydrophobic material here means a material which repels water or is repelled by water. The skirt may be provided with or formed from one or more rows of flexible bristles and/or an elastic strip, and/or one or more wads of foam, etc.

Aside from the main features that have just been mentioned in the previous paragraph, the enclosure according to the invention may exhibit one or more additional features from among the following, considered individually or in technically feasible combinations:
the first material has a water absorption less than 4% in accordance with the protocol for moisture absorption in a standard environment of 23° C./50% of international standard DIN EN ISO 62. In a particularly advantageous manner, the first material has a moisture absorption less than 2% in accordance with the protocol for absorption of moisture in a standardized environment of 23° C./50% of international standard DIN EN ISO 62. Furthermore, the synthetic materials are advantageously chosen for the fact that their hydrophobic properties are superior to those of materials of natural origin. The hydrophobic first material may also be selected in accordance with the protocol for moisture absorption immersed in water of international standard DIN EN ISO 62. In that case, the hydrophobic first material has a moisture absorption less than 9%, and particularly advantageously less than 5%, according to the protocol for the absorption of moisture when immersed in water from international standard DIN EN ISO 62;
the skirt comprises a second part made from an abrasion-resistant second material. The use of a second material that is resistant to abrasion makes it possible to increase the life of the skirt when the protective enclosure is being operated on an industrial scale. Specifically, for applications such as the scaling of concrete, each jet of fluid at a cryogenic temperature dispensed onto a surface that is to be treated, i.e. to be scaled for example, shatters the surface that is to be treated and propels the constituent materials thereof in all directions. These materials then strike the inside of the protective enclosure, referred to as an extraction bell, and the skirt. This has the effect of gradually wearing away the elements of which the skirt is made. This skirt is made up of two parts in order to ensure good sealing at the level of the extraction bell, the first part making it possible to avoid the build up of external moisture so as to prevent ice from forming on the skirt and keep it sufficiently flexible, and the second part blocking the particles, i.e. concrete dust for example in the case of the scaling of concrete, toward the inside of the bell. The abrasion resistance of a material can be quantified in different ways. For example, it may be quantified by the wear rate of said material, which rate can be expressed in mm³/N/m or in cm³/cm/kg.
the first part is situated level with an external peripheral zone of the skirt and the second part is situated level with an internal peripheral zone of the skirt. The external moisture needs to be blocked by the part situated at the level of the external peripheral zone of the skirt whereas the particles generated inside the bell need to be confined therein by being blocked by the second part positioned at the level of the internal peripheral zone of the skirt.
the first part and the second part are coincident. The first and the second part may be one and the same part and in that case made of materials that are both abrasion resistant and hydrophobic. In this way, the first and second materials may be one and the same material;
the first material and the second material are selected from the following materials:
   polybutylene terephthalate (PBT);
   polypropylene (PP);
   aramids;
   polyetheretherketone (PEEK);
   polyamide 6,6;
   polyamide 6,10;
   polyamide 6,12 and
   polyamide 11.

These materials are chosen both for their hydrophobic qualities and for their ability to resist abrasion;
the first part comprises bristles, said bristles being made from the hydrophobic first material. The bristles of the first part may be grouped in bundles of bristles;
the second part comprises bristles, said bristles being made from the abrasion-resistant second material. The bristles of the second part may be grouped in bundles of bristles;
the length of the bristles of the first part is greater than the length of the bristles of the second part. Such a configuration of the skirt makes it possible to improve the sealing between the mobile fluid dispensing tool and the surface that is to be treated. Specifically, this configuration allows at least 95%, and up to 98%, of the amount of treated material from the surface that is to be treated by the tool to be collected, whereas a skirt made up of a single length of bristles achieves an efficiency of just 90%. This double barrier of bristles advantageously constitutes a double confinement barrier. The first part comprising bristles situated at the level of the external peripheral zone of the skirt constitutes a first confinement barrier. However, as the protective enclosure, referred to as an extraction bell, moves over the surface that is to be treated during the treatment, a slight opening may be created within this external row allowing the treated, scaled particles to pass through this first confinement barrier. The second portion of bristles situated at the level of the internal peripheral zone of the skirt makes up for this lack of sealing. The bristles of the first and second parts may be made of a material of the same nature or of different natures;
the bristles of the first part and/or second part have a diameter of between 0.2 mm and 0.5 mm. This range of values makes it possible to ensure sufficient flexibility of the skirt bristles;
the bristles of the first part are arranged in three concentric rows of bristles and/or the bristles of the second part are arranged in three concentric rows of bristles. Particularly advantageously, the bristles of two adjacent rows are arranged in a staggered configuration;
the open end of said enclosure has a conical or pyramid-shaped cross section. Such a cross section advantageously makes it possible to create a Venturi effect at the open end of the extraction bell so as to prevent the creation of a dead zone and the build-up of scaled-off materials (chippings, dust) in a zone of the protective enclosure. A dead zone would be a zone through which a stream of the dispensed fluid did not pass.

The invention also relates to a method for defining the length of the bristles of a skirt of an enclosure for protecting a mobile fluid-dispensing tool according to one of the embodiments described hereinabove, said tool comprising at least one fluid dispensing nozzle, said skirt comprising a first part comprising bristles and a second part comprising bristles, the first part being situated level with an external peripheral zone of the skirt, the second part being situated level with an internal peripheral zone of the skirt, said method comprising:
a step of defining a firing distance, said firing distance corresponding to the distance between a distal end of the fluid dispensing nozzle and a surface to be treated by the mobile tool;
a step of defining a depth of pass, said depth of pass corresponding to the depth of material to be removed by the treatment of the surface that is to be treated;
a step of defining a first length of bristles for the first part, said first length being tailored so that the distance between the distal end of the fluid dispensing nozzle and a distal end of the bristles of the first part is equal to the sum of the firing distance and of the depth of pass increased by a value of between 0 and 40 mm.
a step of defining a second length of bristles for the second part, said second length being tailored so that the distance between the distal end of the fluid dispensing nozzle and a distal end of the bristles of the second part is equal to the firing distance increased by a value of between 0 and 20 mm.

The bristle length thus defined makes it possible to conform to the geometry of the surface that is to be treated, both in terms of surface irregularities and also in terms of the step change that defines the boundary between the zone already treated and the zone yet to be treated of the surface being treated.

The invention also relates to a working installation using at least one high-pressure jet of fluid at a cryogenic temperature, comprising:
a source of fluid at a cryogenic temperature connected fluidically to a mobile tool comprising at least one fluid dispensing nozzle to dispense at least one high-pressure jet of said fluid at a cryogenic temperature; and
a protective enclosure according to one of the embodiments described hereinabove, said enclosure being arranged around the mobile tool and fluidically connected to suction means, the open end of said enclosure forming the extraction bell around the mobile tool.

### BRIEF DESCRIPTION OF THE DRAWINGS

Further features and advantages of the invention will become apparent from reading the following description, with reference to the attached figures which illustrate:

FIG. 1: a schematic view of a working installation using a tool for dispensing fluid at a cryogenic temperature;

FIGS. 2a (side view) and 2b (view from beneath): a mobile tool with which the installation of FIG. 1 is equipped;

FIG. 3: a schematic view of a working installation using a jet of fluid at a cryogenic temperature and comprising a mobile tool protective enclosure and a mobile tool;

FIGS. 4a (view from beneath) and 4b (view in cross section): schematic views of one embodiment of a working installation employing a jet of fluid at a cryogenic temperature comprising a mobile tool protective enclosure and a mobile tool; and

FIG. 5: a schematic view of a working installation employing a jet of fluid at a cryogenic temperature comprising a mobile tool protective enclosure and a mobile tool and a surface in the process of being treated.

FIG. 6: a schematic view of the skirt showing a first example of how the first and second constituent parts of the skirt with which the enclosure of the invention is equipped are set out.

FIGS. 7a to 7c: schematic views of the skirt showing examples of the layout of bristles on the first and second parts when these are coincident.

For greater clarity, elements that are identical or similar are identified by identical reference signs in all the figures.

### DETAILED DESCRIPTION OF ONE EMBODIMENT

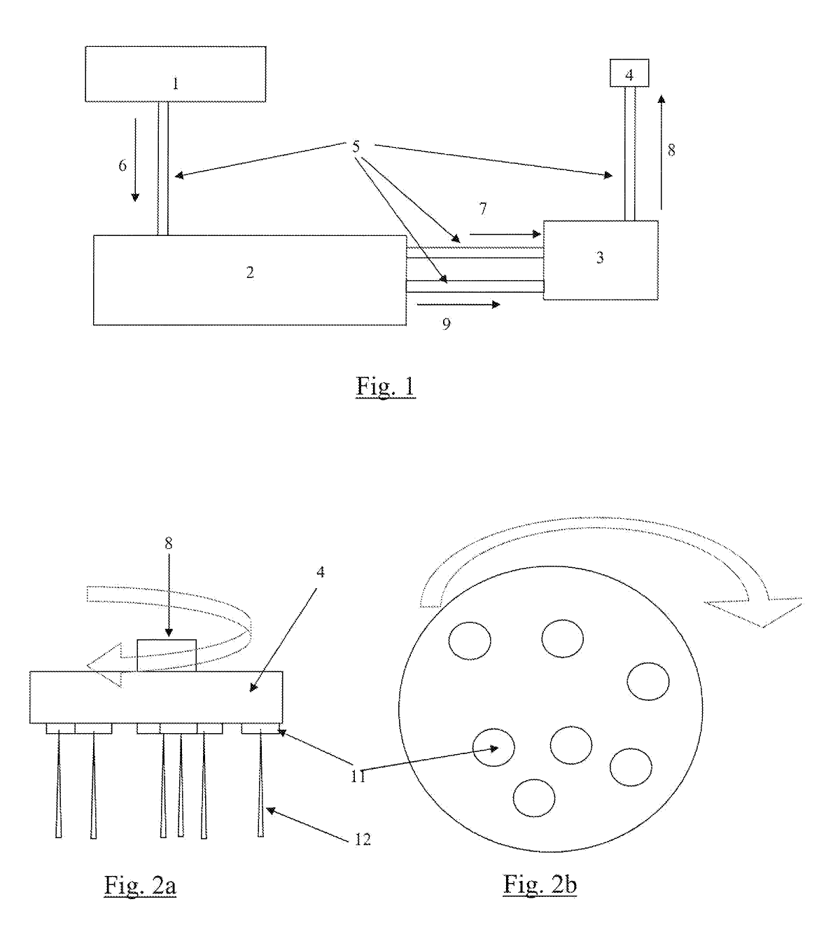

FIG. 1 schematically depicts a working installation employing a source of fluid at a cryogenic temperature for stripping, scaling, surface treatment or the like using jets of cryogenic liquid usually comprising a storage reservoir 1, such as a tank, of liquid nitrogen (hereinafter referred to as LN2) which, via a line 6 for conveying liquid nitrogen at low pressure, namely around 3 to 6 bar and at a temperature of around −180° C., supplies a compression device 2 which has a compressor and internal upstream heat exchanger allowing the liquid nitrogen to be raised to an ultra high pressure (UHP).

The compression device 2 therefore allows the LN2 from the storage reservoir 1 to be compressed. The LN2 at the first pressure (UHP) is then carried, via a conveying line (7), as far as an external downstream heat exchanger 3 where the UHP LN2 is cooled with liquid nitrogen at atmospheric pressure (at 9) in order typically to obtain UHP liquid nitrogen at a cryogenic temperature. This results in LN2 at ultra high pressure (UHP) typically higher than 300 bar, generally of between 1000 bar and 4000 bar, advantageously of between around 3000 and 4000 bar, and at a cryogenic temperature comprised for example between −100° C. and −200° C., typically between −125° C. and −160° C., which is sent (at 8) to the mobile fluid dispensing tool 4 for stripping or the like that delivers one or more jets of UHP liquid nitrogen, generally several jets.

The high-capacity reservoir 1, such as a tanker truck tank or a storage reservoir with a capacity of several thousand liters of liquid nitrogen, is generally situated outside the buildings, namely in the open air. It may be fixed or mobile.

The high-capacity reservoir 1 is connected to the installation in the conventional way, namely by way of lagged piping comprising one or more control valves.

Furthermore, the conveying of the LN2 between the various elements of the system is also done via lagged piping. The overall liquid flow rate is approximately 20 l/min, namely 15 m³/min of gaseous nitrogen.

Moreover, in order to increase the size of the treated surface, namely the surface that is stripped or the like, use is typically made of a tool 4 equipped with nozzles 11 of the kind used in UHP water jet methods, but here supplied with UHP LN2 (at 8) and that are rotated or oscillated in order to obtain rotary or oscillatory jets 12 of UHP LN2 which are used to strip (or equivalent) the surface that is to be treated, as illustrated in FIGS. 2a (side view) and 2b (view from beneath).

In a way known per se, the nozzle holder tool 4 is usually set in rotation by a set of gears, with or without a transmission belt, driven by an electric or pneumatic motor via a first rotary transmission shaft or spindle connected to the motor, a transmission box or gearbox comprising a transmission mechanism with a set of internal gears, and a second transmission shaft or spindle, in this instance rotary, itself connected to the mobile tool 4 equipped with the nozzles.

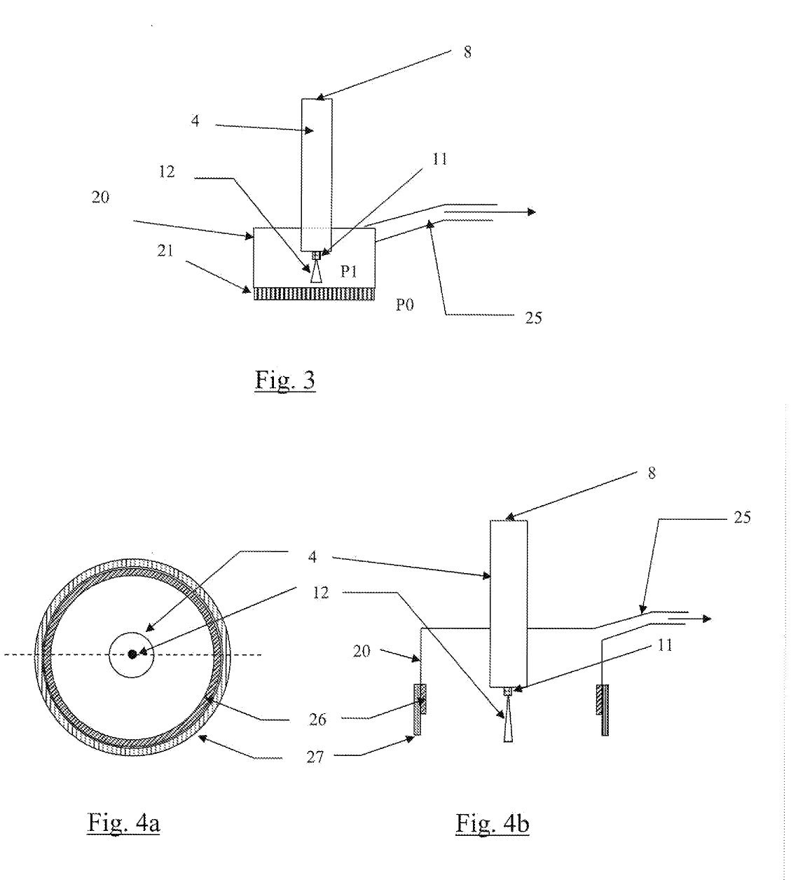

As illustrated in FIG. 3, in order to suck up the residue from the stripping operation and limit the risks of anoxia to the operator which are generated by the gaseous nitrogen, conveyed by the conveying line 8 and then delivered by the nozzles 11, which would be released and which would build up in the place where the surface treatment is being performed, a protective enclosure 20 forming an extraction bell is generally arranged around the nozzle holder tool 4 that distributes the jets 12 of liquid nitrogen. The bell 20 has an open end which is positioned facing the surface that is to be treated and via which the jets 12 of pressurized cryogenic liquid delivered by the nozzles 11 emerge.

This protective enclosure 20 is generally equipped, at its open end that comes into contact with or in close proximity to the surface being stripped, with a flexible skirt 21 or apron, which acts as a mechanical and sealing barrier between the extraction bell 20 and the surface that is to be treated. This skirt 21 may be provided with one (or more) row(s) of flexible bristles, with one or more elastic strips, with one or more wads of foam, etc.

A conventional suction-type extraction system 25, comprising a suction pump, one or more filters or other purification or filtration devices, is in fluidic communication with the inside of the protective enclosure 20 and allows the surface residue to be sucked up effectively and also makes it possible to prevent the re-release of nitrogen into the room in which the surface treatment is being performed.

Stated differently, the extraction bell 20 constitutes a vacuum enclosure surrounding the tool 4, making it possible to collect and remove all or some of the nitrogen delivered by the nozzles 11 and the dust generated by the stripping or similar method. The pressure P1 prevailing in the protective enclosure 20 is preferably lower than atmospheric pressure P0 prevailing outside the enclosure 20, namely in the room in which the tool 4 is installed. If the pressure P1 is higher than the pressure P0, the suction is insufficient and the sealing of the extraction bell 20 is no longer assured.

Thus, ambient air and moisture can be sucked up. The frigories supplied by the jets 12 of liquid nitrogen cool the protective enclosure 20, the elements that make up the flexible skirt 21 such as one (or more) row(s) of flexible bristles and/or one or more elastic strips, and the moisture coming from the sucked-up air that could lead to the formation of ice, particularly at the level of the flexible skirt 21.

The formation of ice at the level of the flexible skirt 21 causes a stiffening of the elements of which said skirt is made and a loss of flexibility gradually leading to a lack of sealing of the extraction bell 20, and therefore to a loss of suction effectiveness.

Thus, the skirt 21 comprises a first part made of a hydrophobic material. The hydrophobic nature of a material can be quantified by taking measurements of moisture absorption, for example in accordance with the procedures described in international standard DIN EN ISO 62. By way of example, the table below gives a list of synthetic and natural materials with their moisture absorption values.

TABLE 1

| | |
|---|---|
| Moisture | |
| absorption in a | Moisture |
| standardized | absorption |
| environment of | immersed in |
| 23° C./50% RH | water |
| (DIN EN | (DIN EN |
| ISO 62) | ISO 62) |

Synthetic material

| Name | code | | |
|---|---|---|---|
| Polyimide | PI | 2.6% | 3.6% |
| Aromatic polyamide | | 3% | |
| (aramid) | | | |
| Polyamide/imide | PAI | 2.5% | 4.5% |
| Polyetherketoneether- | PEKEKK | <0.25% | 0.05% |
| ketoneketone | | | |
| Polyetheretherketone | PEEK | 0.1% | <1% |
| Poly(phenylene sulfide) | PPS | 0.01% | |
| Polysulfone | PSU | 0.2% | 0.8% |
| Polyethersulfone | PES | 0.7% | 2.1% |
| Poly(phenylene sulfone) | PPSU | 0.37% | 1.1% |
| Polyetherimide | PEI | 0.7% | 1.25% |
| Polytetrafluoroethylene | PTFE | 0.05% | |
| Ethylene | E/CTFE | <0.05% | 0.03% |
| chlorotrifluoroethylene | | | |
| Poly(vinylidene fluoride) | PVDF | <0.05% | <0.05% |
| Polychlorotrifluoroethylene | PCTFE | <0.05% | |
| Polyamide - Nylon 4,6 | PA4,6 | 3.7% | 14% |
| Polyamide - Nylon 6,6 | PA6,6 | 2.5% | 8.5% |
| Polyamide - Nylon 6,10 | PA6,10 | 1.20% | 3% |
| Polyamide - Nylon 6,12 | PA6,12 | 1% | 3% |
| Polyamide - Nylon 6 | PA6 | 3.2% | 9% |
| Polyamide - Nylon 12 | PA12 | 1.2% | 1.6% |
| Polyamide - Nylon 11 | PA11 | 0.8% | 1.9% |
| Polycarbonate | PC | 0.15% | 0.36% |
| Poly(4-methyl-1-pentene) | PMP | <0.05% | 0.01% |
| Polyethylene | PET | 0.10% | 0.5% |
| Poly(butylene terephthalate) | PBT | 0.20% | 0.4% |
| Polypropylene | PP | <0.1% | <0.1% |
| Poly(methyl methacrylate) | PMMA | 1% | 2% |
| Acrylonitrile-butadiene- | ABS | 0.4% | 0.7% |
| styrene | | | |
| Poly(phenylene ether) | PPE | 0.1% | 0.2% |
| Poly(vinyl chloride) | PVC | 0.2% | 0% |

The skirt 21 also comprises a second part made from a second material that is resistant to abrasion so as to avoid the dissemination of the particles, for example during scaling operations. The hydrophobic materials in table 1 have been classified as a function of their abrasion resistance into three categories: highly resistant, resistant, and low resistance in table 2 below.

TABLE 2

| Highly resistant | Resistant | Low resistance |
|---|---|---|
| Aramids | PA 6,6 | PET |
| PA 11 | PEEK | PVC |
| PA 6,12 | PBT | PE |
| PA 6,10 | PP | PPS |
| | | PPS |
| | | POM |
| | | PTFE |
| | | PC |
| | | PMMA |
| | | ABS |

In the light of the data in tables 1 and 2 it is possible to state that the skirt can be made of a single type of element, said element being made of a single material that is hydrophobic and abrasion resistant; what that means in this case is that the first part and second part are coincident. In this first case, the ring is made up of a single row of brushes of the same material, with one or more (outer) rows of bristles being longer than the other so as to guarantee sealing against the scaled face.

Alternatively, it is possible for the first part and the second part not to be coincident and in such a case, the first part is chosen to be from a hydrophobic material and the second part from a material that is abrasion resistant. In this second case, the ring is made up of two rows of brushes of two distinct materials, with, at the level of the internal peripheral zone, one or more rows of bristles that are abrasion resistant and short so as to lie tangential to the surface being treated (i.e. concrete surface in the case of scaling for example), and, at the level of the external peripheral zone, one or more rows of hydrophobic bristles that are long so as to conform as well as possible to the step change in level left by the tool.

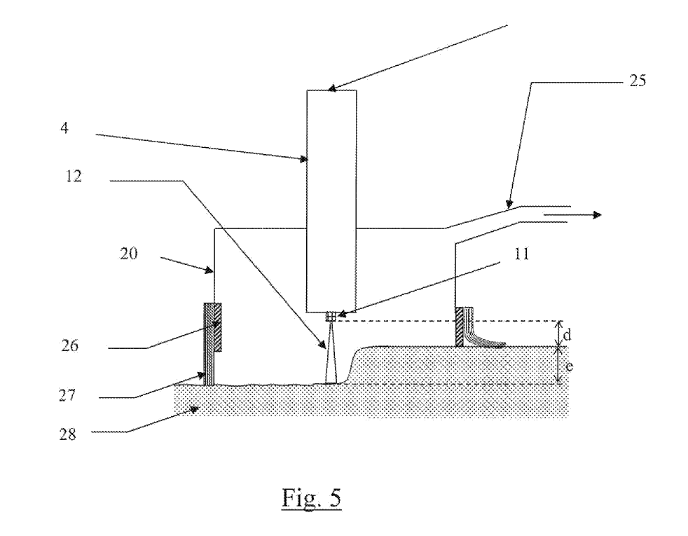

FIGS. 4a, 4b and 5 illustrate one embodiment of the invention in the case of a circular bell with a skirt 21 the first part of which is made up of bristles 27 and the second part of which is made up of bristles 26. The first part is situated at the level of an external peripheral zone of the skirt, i.e. situated furthest away from the jets of liquid nitrogen 12. The second portion of bristles 26 is situated at the level of an internal peripheral zone of the skirt, i.e. situated closest to the jets of liquid nitrogen 12. They are both made of materials that are resistant or very resistant to abrasion, by way of example chosen from polybutylene terephthalate (PBT), polypropylene (PP), aramids, polyetheretherketone (PEEK), polyamide 6,6, polyamide 6,10, polyamide 6,12 and polyamide 11. It can be seen from FIGS. 4b and 5 that the length of the bristles 26 of the second part is less than the length of the bristles 27 of the first part. This makes it possible to improve the sealing of the skirt.

FIG. 5 shows the concepts of firing distance and depth of pass. The firing distance denoted (d) in FIG. 5 corresponds to the distance between the distal end (i.e. the end most distant from the tool) of the liquid nitrogen ejection nozzle or nozzles 11 and the surface that is to be treated. The depth of pass denoted (e) in FIG. 5 is defined as being the thickness of material that is removed, scaled off, under the action of the jet or jets of liquid nitrogen.

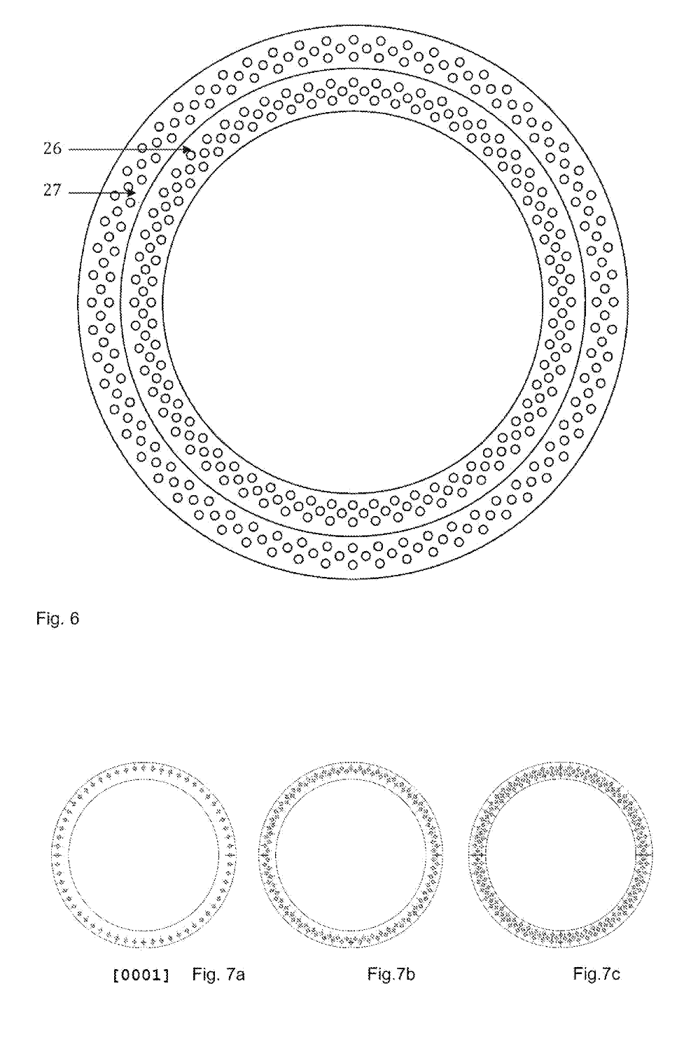

FIG. 6 illustrates a first example of a layout of the first and second constituent parts of the skirt with which the enclosure is equipped. The bristles of the first part 26 form an inner ring and the bristles of the second part 27 form an outer ring. The bristles of the first part are grouped together in several bundles of bristles, the bristles of the second part are likewise grouped together into several bundles of bristles. By way of indication, a bundle of bristles may comprise a number of bristles for example of between 60 and 100. In the example of FIG. 6, the bundles of bristles are arranged in a staggered configuration. The inner ring, positioned closest to the tool, makes it possible to arrest particles thrown up during the operations, and the outer ring placed at the periphery of the open end of the bell makes it possible to block out moisture from the ambient air.

FIGS. 7a to 7c illustrate examples of layouts of bristles in the first and second parts when these coincide. In the example of FIG. 7a, the first part and the second part coincide and are set out in a single row of bristles, and even bundles of bristles in this embodiment. In the example of FIG. 7b, the first part and second part coincide and are set out as two rows of bristles and even bundles of bristles in this embodiment, concentrically and in a staggered configuration. In the example of FIG. 7c, the first part and second part coincide and are set out as three rows of bristles, and even bundles of bristles in this embodiment, which are concentric and in a staggered configuration. The use of several rows of bristles in one and the same ring is to be encouraged as it makes it possible to increase the sealing of the system. The greater the number of rows, the better the sealing of the system will be. Specifically, the presence of several rows of bristles makes it possible to reduce the openings in the skirt, thus limiting the escape of particles.

In order to ensure a good seal, the length of the bristles is defined/parameterized as follows:
the distance between the end of the liquid nitrogen ejection nozzle(s) 11 and the end of the bristles 26 of the second part in contact with the surface treated needs to be equal to the firing distance increased by a value of between 0 and 20 mm; and
the distance between the end of the liquid nitrogen ejection nozzle(s) 11 and the end of the bristles 27 of the first part in contact with the treated surface needs to be equal to the firing distance plus the depth of pass increased by a value of between 0 and 40 mm.

For an application to the scaling of concrete, the firing distance is generally between 5 mm and 10 mm. The distance between the end of the liquid nitrogen ejection nozzle(s) 11 and the end of the bristles 26 of the second part (internal row) in contact with the treated surface 28 is between 10 and 30 mm. Considering a depth of pass of between 5 mm and 30 mm, the distance between the end of the liquid nitrogen ejection nozzle(s) 11 and the end of the bristles 27 of the first part (outer row) in contact with the treated surface 28 is between 30 and 50 mm.

In the example set out here, the bristles that make up the inner and outer rows have a diameter of between 0.2 and 0.5 mm, making it possible to ensure good flexibility of the skirt.

The invention is not restricted to the embodiments described hereinabove with reference to the figures and alternative forms may be conceived of without departing from the scope of the invention.

1.-14. (canceled)

15. A protective enclosure (20) for a mobile tool (4) for dispensing fluid at a cryogenic temperature, said protective enclosure (20) comprising an open end forming an extraction bell, said open end comprising a skirt (21), wherein the skirt (21) comprises a first part made from a hydrophobic first material.

16. The enclosure of claim 15, wherein the first material has a water absorption less than 4% in accordance with the protocol for moisture absorption in a standard environment of 23° C./50% of international standard DIN EN ISO 62.

17. The enclosure of claim 15, wherein the skirt (21) comprises a second part made from an abrasion-resistant second material.

18. The enclosure of claim 17, wherein the first part is situated level with an external peripheral zone of the skirt and the second part is situated level with an internal peripheral zone of the skirt.

19. The enclosure of claim 17, wherein the first part and the second part are coincident.

20. The enclosure of claim 17, wherein the first material and the second material are selected from the following materials:
polybutylene terephthalate (PBT);
polypropylene (PP);
aramids;
polyetheretherketone (PEEK);
polyamide 6,6;
polyamide 6,10;
polyamide 6,12;
polyamide 11; and combinations thereof.

21. The enclosure of claim 15, wherein the first part comprises bristles, said bristles being made from the hydrophobic first material.

22. The enclosure of claim 17, wherein the second part comprises bristles, said bristles being made from the abrasion-resistant second material.

23. The enclosure of claim 21, wherein the second part comprises bristles, said bristles being made from the abrasion-resistant second material, and wherein the length of the bristles of the first part is greater than the length of the bristles of the second part.

24. The enclosure of claim 23, wherein the bristles of the first part and/or second part have a diameter of between 0.2 mm and 0.5 mm.

25. The enclosure of claim 23, wherein the bristles of the first part are arranged in three concentric rows of bristles and/or in that the bristles of the second part are arranged in three concentric rows of bristles.

26. The enclosure of claim 15, wherein the open end of said enclosure has a conical or pyramid-shaped cross section.

27. A method for defining the length of the bristles of a skirt of an enclosure for protecting a mobile fluid-dispensing tool, said tool comprising at least one fluid dispensing nozzle, said skirt comprising a first part comprising bristles and a second part comprising bristles, the first part being situated level with an external peripheral zone of the skirt, the second part being situated level with an internal peripheral zone of the skirt, said method comprising:
a step of defining a firing distance (d), said firing distance (d) corresponding to the distance between a distal end of the fluid dispensing nozzle and a surface (28) to be treated by the mobile tool;
a step of defining a depth of pass (e), said depth of pass (e) corresponding to the depth of material to be removed by the treatment of the surface that is to be treated;
a step of defining a first length of bristles for the first part, said first length being tailored so that the distance between the distal end of the fluid dispensing nozzle and a distal end of the bristles of the first part is equal to the sum of the firing distance (d) and of the depth of pass (e) increased by a value of between 0 and 40 mm; and
a step of defining a second length of bristles (26) for the second part, said second length being tailored so that the distance between the distal end of the fluid dispensing nozzle and a distal end of the bristles of the second part is equal to the firing distance (d) increased by a value of between 0 and 20 mm.

28. A working installation using at least one high-pressure jet of fluid at a cryogenic temperature, comprising:
a source of fluid at a cryogenic temperature connected fluidically to a mobile tool comprising at least one fluid dispensing nozzle to dispense at least one high-pressure jet of said fluid at a cryogenic temperature; and
a protective enclosure of claim 1, said enclosure being arranged around the mobile tool and fluidically connected to suction means, the open end of said enclosure forming the extraction bell around the mobile tool.
